(19) United States
(12) Patent Application Publication
(10) Pub. No.: US 2020/0270077 A1
(43) Pub. Date: Aug. 27, 2020

(54) Loading Arm Device

(71) Applicant: SVT GmbH, Schwelm (DE)

(72) Inventor: Harm Stöver, Wetter (DE)

(21) Appl. No.: 16/800,318

(22) Filed: Feb. 25, 2020

(30) Foreign Application Priority Data
Feb. 27, 2019 (DE) 10 2019 202 647.8

(51) Int. Cl. B65G 67/60; B65G 43/02

(52) U.S. Cl. CPC B65G 67/606; B65G 2814/0397; B65G 43/02

(57) ABSTRACT

A loading arm device, serving in particular for loading fluids, including a main arm supported by a base station. An external arm is pivotally connected with the main arm. Further, the rear part of the main arm is connected with a counter-weight arm. A coupling element guarantees that at different swivel positions, the counter-weight arm is arranged parallel to the external arm. Further, switching elements are provided to trigger a switching operation at a maximum scissors angle between the main arm and the external arm. One of the switching elements is fixedly connected with the counter-weight arm or the external arm, and the other switching element is rotatably connected with the main arm.

### CROSS-REFERENCE TO RELATED APPLICATION

This application claims priority to German Patent Application No. 10 2019 202 647.8 filed Feb. 27, 2019, the disclosure of which is hereby incorporated by reference in its entirety.

### BACKGROUND

The invention relates to a loading arm device which is in particular suited for loading fluids.

Such devices, as described e.g. in EP 2 757 967, comprise a main arm and an articulated external arm which is connected with the main arm. The main arm is pivotally supported by a base element such as a vertical column. The external arm is pivotally connected with a front end of the main arm, and a counter-weight arm is provided e.g. at the opposite rear part of the main arm (rear arm). The outer arm is coupled with the counter-weight arm via a coupling element such that the two arms are always parallel to each other when the arms are moved. A corresponding coupling may be realized using coupling rods, coupling cables or the like, as known e.g. from EP 2 757 067.

Using such loading arms, e.g. fluids are filled into transport tanks provided on ships. Since these may possibly be toxic or flammable fluids, fluid leakage must be prevented. There is a serious risk that a ship drifts off during the filling operation, causing the loading arm or the ship-side pipe to be damaged or torn off. It is mandatory to secure that fluid leakage due to damage is avoided. This is achieved by closing one valve or two valves within short time, as soon as there is a risk of the loading arm being damaged or even torn off, the valves typically being located at the free end of the external arm. At the same time or immediately after the closing of the valves a separating coupling is separated. This is realized by providing a switching means. A corresponding switching means comprises two switching elements such as e.g. a switching plate and a proximity switch. Typically, one of the two switching elements (e.g. the switching plate) is arranged on the main arm in that region in which the main arm is connected with the counter-weight arm. The second switching element (e.g. the proximity switch) is connected with the counter-weight arm. A deflection of the arm causes the two switching elements to move towards each other, when reaching a predetermined maximum scissors angle between the external arm and the main arm, the switching plate is switched by the proximity switch. This causes the valves to close and the coupling to be opened.

At the maximum scissors angle, great forces and moments occur in the external arm and in the main arm, in particular in an upper position of the arms. Thus, the entire loading arm device has to be of an extremely solid design resulting in great weight both of the individual arms and the counter-weight provided at the counter-weight arm. In a lower position of the external arm which occurs e.g. at low water level, the forces and moments occurring are significantly smaller so that the above problem does not exist in this case.

However, it is not readily possible to define different maximum scissors angles for different positions of the external arm, using electronic components such as a rotary encoder. For reasons of safety, the relevant regulations (e.g. DIN EN ISO 16904, OCIMF) or customer specifications stipulate or at least recommend that such safety-relevant switching means have to be proximity switches, possibly with SIL rating or 2oo3 voting.

It is an object of the invention to provide a loading arm device in which the maximum forces and moments occurring are reduced.

### SUMMARY

The object is achieved according to the invention with a loading arm device with the features of claim 1.

The loading arm device of the invention is suited in particular for loading fluids into tanks provided on ships. The loading arm device has a main arm pivotally supported by a base element. The base element may in particular be a stationary element e.g. a support frame, a vertical column or the like. An external arm is pivotally connected with a front end of the main arm. At its free end, the main arm preferably has a coupling for connection with a fluid pipe e.g. provided by a ship.

A counter-weight arm is connected with e.g. the rear part of the main arm (rear arm). The former carries a counter-weight or is configured such that it serves as a counter-weight. Further, the loading arm device comprises a coupling element coupling the counter-weight arm with the external arm such that the counter-weight arm and the external arm are parallel to each other in different swiveled positions. The coupling element specifically guarantees that the counter-weight arm is parallel to the external arm in any optional position of the external arm. Moreover, the loading arm device has a switching means with at least two switching elements. The two switching elements may be rotated relative to each other to trigger a switching operation at a maximum scissors angle, i.e. a maximum angle between the main arm and the external arm.

According to the invention one of the switching elements is rigidly connected with the counter-weight arm or the external arm. The other or second switching element is rotatably connected with the main arm. Due to this rotatable connection of one of the two switching elements with the main arm, it is possible that the switching means triggers at different maximum scissors angles which depend on the position of the main arm. For example, by means of the switching means of the invention, it is possible to allow a larger scissors angle for triggering a switching operation at a low position than at an upper of high position of the main arm. As a consequence, the switching operation is triggered earlier at an upper position or at higher positions that at a lower position. This has the advantage that the forces and moments occurring are smaller at higher positions and in particular at the upper position that in prior art, since a smaller maximum scissors angle exists.

In a particularly preferred embodiment of the invention the rotatable switching element is connected with the base element or a stationary support element via an actuation means. Thus, due to the actuation means, swiveling the main arm causes a rotation of the rotatable switching element relative to the main arm. By swiveling the main arm, the position of the main arm and the pivotable switching element changes with respect to each other. It is further preferred that the actuation means is an actuation linkage.

The main arm is preferably connected with the base element via a hinge. It is further preferred that the main arm has a rear arm arranged between the hinge and the counter-weight arm, as well as an internal arm arranged between the hinge and the external arm. The rear arm and the internal arm are preferably integral or at least rigidly connected with each other.

It is further possible that the internal arm and the rear arm are not one part with a common fulcrum, but each has a fulcrum of its own, wherein these are arranged one above the other. With such a design of a loading arm, a parallel linkage causes the internal arm and the rear arm to rotate simultaneously and in the same direction. Thus, it is possible to quasi reposition the rear arm upward so as to be able to realize an extremely short vertical column in this manner.

Preferably, the rotatable switching element is connected with the rear arm and the fixed switching element is connected with the counter-weight arm. As an alternative, the rotatable switching element may also be connected with the internal arm, in case of which the fixed switching element is connected with the external arm.

Preferably, one of the switching elements is a switching plate and the other switching element is a proximity switch.

It is further preferred that the coupling element is a coupling linkage and/or coupling cables.

Further, it is preferred and possible with the loading arm device of the invention to define an initial position of two switching elements relative to each other. In particular this is the maximum distance between the two switching elements. Thereby, a maximum scissors angle is set, wherein the maximum scissors angle is the largest at the lowest position and decreases upwards to the uppermost position. Setting the initial position may be effected e.g. by setting the position of the rotatable switching elements by means of the actuation means.

The loading arm device of the invention further has the advantage that, due to the smaller forces and moments occurring, the external arm and the main arm may be designed to be lighter. As a result, a lighter counter weight may be provided. This significantly reduces the costs of the loading arm device.

The invention will be described in more detail below with reference to a preferred embodiment and to the accompanying drawings.

### BRIEF DESCRIPTION OF THE DRAWINGS

In the Figures:

FIGS. 1-3 show a loading arm device according to the prior art at different positions, and

FIGS. 4-9 are schematic illustrations of a loading arm device according to a preferred embodiment of the invention at different positions.

### DESCRIPTION OF THE INVENTION

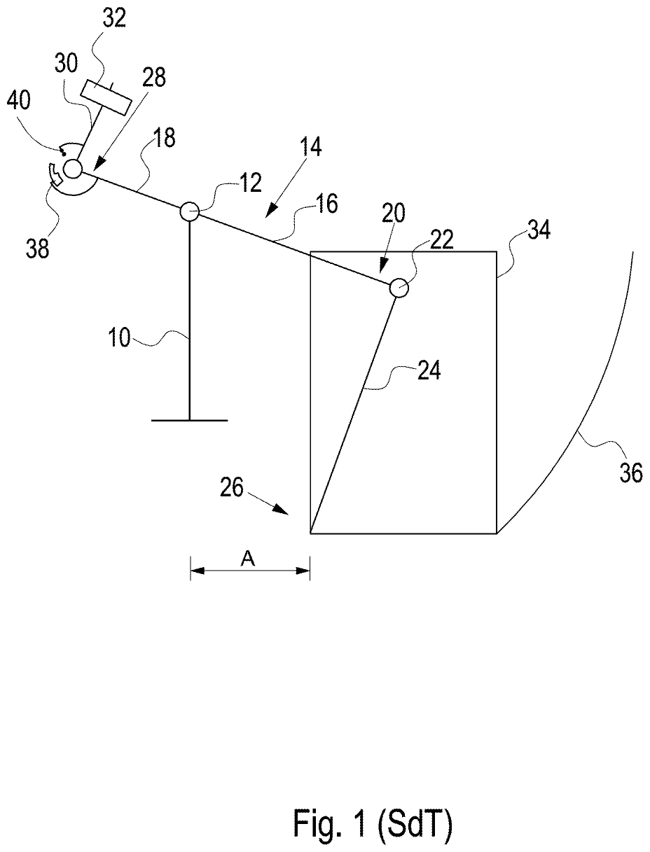

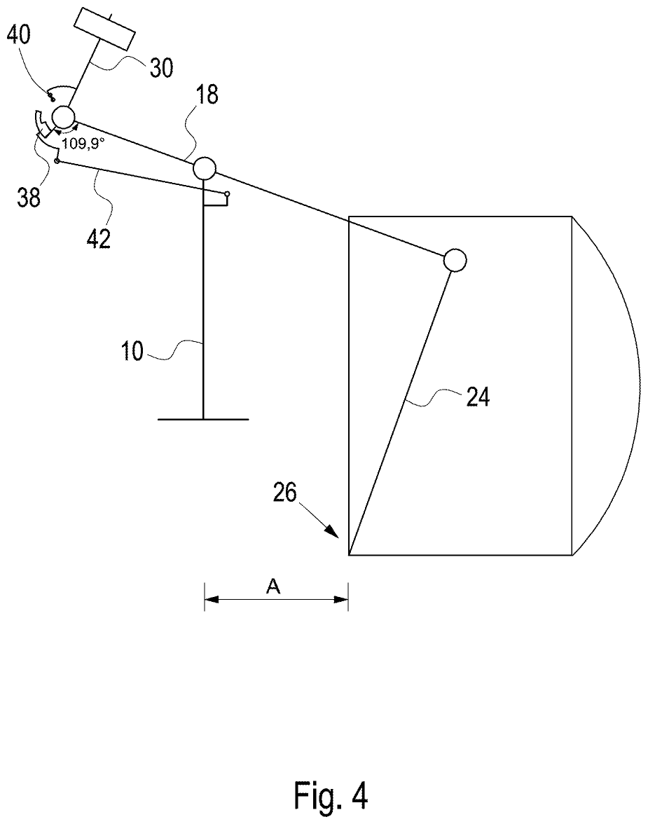

The loading arm device of both the prior art (FIGS. 1-3) and according to an embodiment of the invention (FIGS. 4-9), as illustrated in the Figures, comprises a base element 10 which in the embodiment illustrated is a vertical column. The vertical column 10 has a hinge 12 at its upper end, a main arm 14 being connected with the same. The main arm 14 has an internal arm 16 as well as a rear arm 18 that are fixedly connected with each other or integrally formed, and can therefore always only be swiveled together about the hinge 12.

A hinge 22 is connected with a front end 20 of the main arm or the internal arm. An external arm 24 is connected with the hinge 22. Closing valves (not illustrated) with a separating coupling and a connecting coupling for connecting the external arm with a pipe system provided e.g. on a ship can be provided at a free end of the external arm 24, respectively.

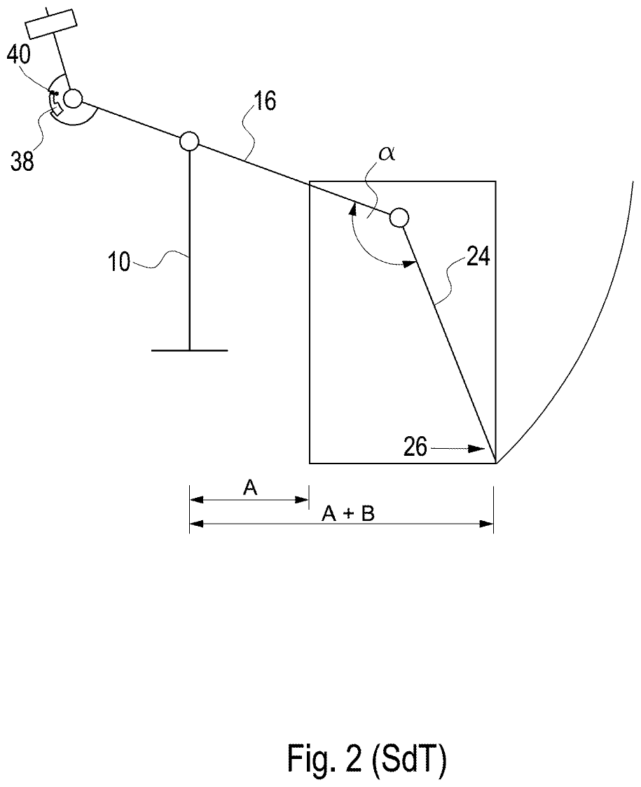

A counter-weight arm 30 is connected with a rear part of the main arm 18, the counter-weight arm carrying a counter-weight 32 in the embodiment illustrated. In the Figures a rectangular line defines a working range 34 within which the free end 26 of the external arm 24 is moved during conventional use. A curved line 36 illustrates the maximum position of the outer end 26 at a maximum scissors angle a (FIG. 2) at which the valves are closed and the separating coupling is separated.

In loading arm devices according to prior art (FIGS. 1-3) a first switching element 38, which in the embodiment illustrated are switching plates, are fixedly connected with the rear arm 18. A second switching element 40, which in the embodiment illustrated are proximity switches, is fixedly connected with the counter-weight arm 30.

FIG. 2 illustrates a lower maximum position of the external arm 24. In this lower maximum position the maximum scissors angle a between the internal arm 16 and the external arm 24 is reached. At this position a switching operation is triggered by the two switching elements 38 and 40. In this regard it should be considered that, depending on the application, the switching element 38 and 40 can also be used to trigger other safety-relevant actions such as e.g. the generation of an alarm signal or the like. Thus, at the lower maximum position (FIG. 2) there is a maximum distance of A+B between the base element 10 and the free end 26 of the external arm 24.

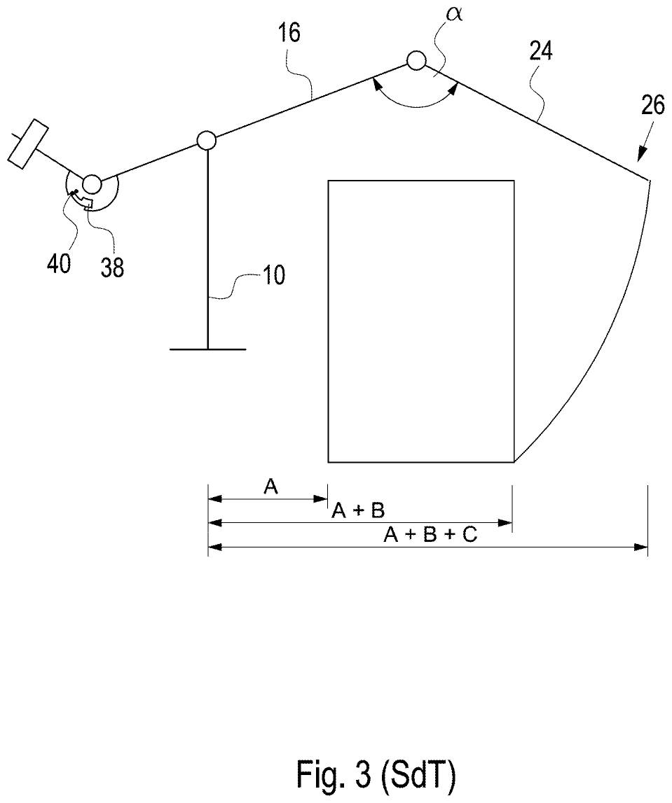

FIG. 3 illustrates the loading arm device of the prior art at an upper maximum position. Also at this position the same maximum scissors angle a between the internal arm 16 and the external arm 24 is reached. Again, a switching operation is triggered at his position by the two switching elements 38 and 40. Here, the deflection of the loading arm device is very large with a distance of A+B+C existing between the outer end 26 and the base element 10. Great forces and moments occur at that position.

According to the preferred embodiment of the invention as illustrated in FIGS. 4-9, not both switching elements 38 and 40 are fixedly connected with the rear arm or the counter-weight arm. Rather, according to the invention, the switching element 40, which may e.g. be proximity sensors, is fixedly connected with the counter-weight arm 30. The other switching element 38, which may e.g. be switching plates, is not fixedly connected with the rear arm 18, but is supported for rotation thereon. For a rotation of the switching element 38, the same is connected with the base element 10 via an actuation means which in the embodiment illustrated is configured as an actuation linkage 42.

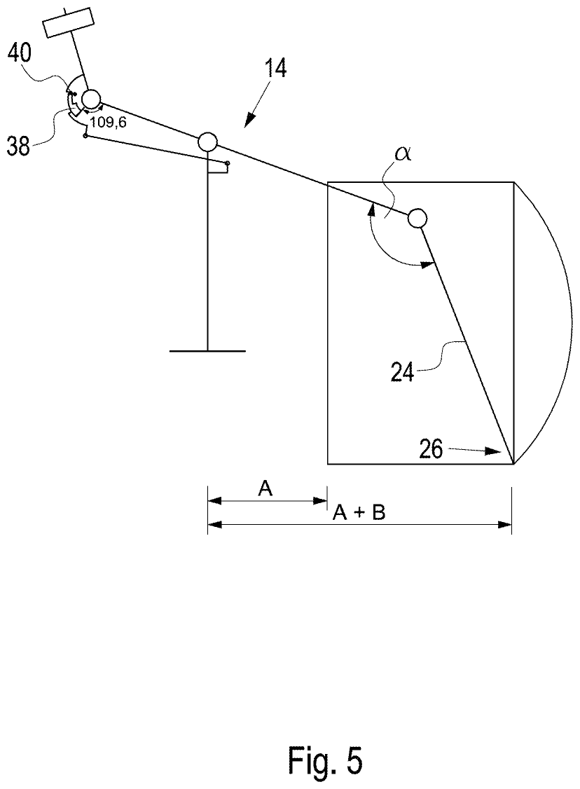

At a lower inner position of the external arm 24 (FIG. 4) the outer end 26 of the external arm 24 is at a distance A from the base element 10. If the external arm 24 is swiveled to a lower outer position (FIG. 5), while the position of the main arm 14 is maintained, the two switching elements 38 and 40 approach each other and the switching operation is triggered. At this position the maximum scissors angle a substantially corresponds to the maximum scissors angle a allowed for the corresponding position of the prior art device (FIG. 2). The distance between the front end 26 of the external arm 24 and the base element 10 thus also is A+B.

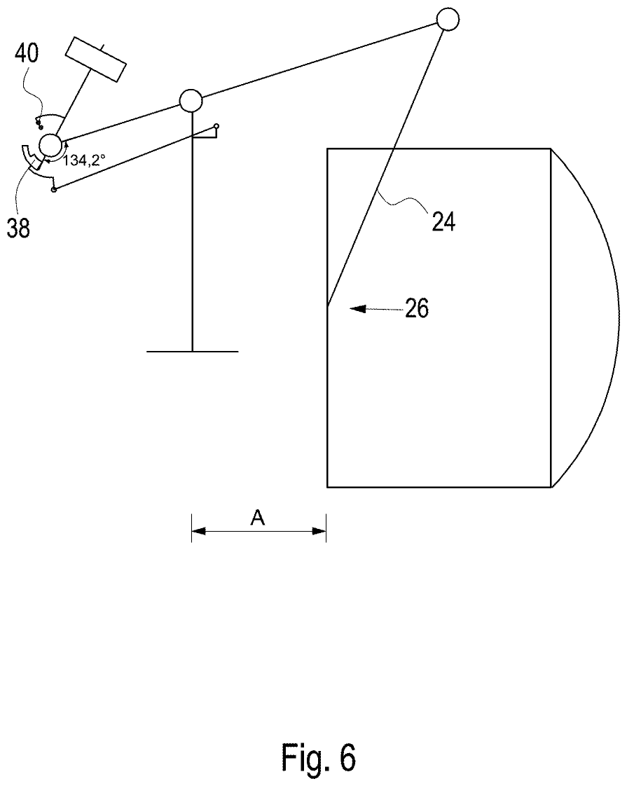

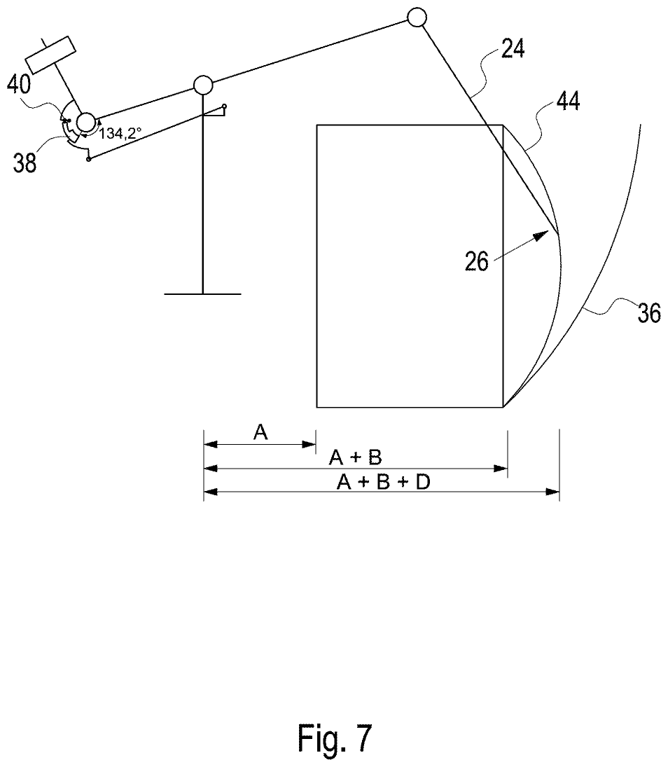

At an intermediate inner position of the external arm, as illustrated in FIG. 6, the two switching elements 38 and 40 are initially arranged at a new distance relative to each other, because the higher position of the main arm 14, with reference to FIG. 4, has caused a rotation of the switching element 38 by means of the exemplary actuation linkage 42. When the external arm is swiveled to an intermediate outer position (FIG. 7), the switching element 40 moves toward the switching element 38 and a switching operation is triggered. Here, the outer end 26 of the external arm 24 is on a curved line 44. The latter differs from the line 36 of the prior art. Thus, a triggering or reaching the maximum allowable scissors angle occurs earlier, i.e. already at a distance of A+B+D of the outer end 26 of the external arm 24 to the base element 10.

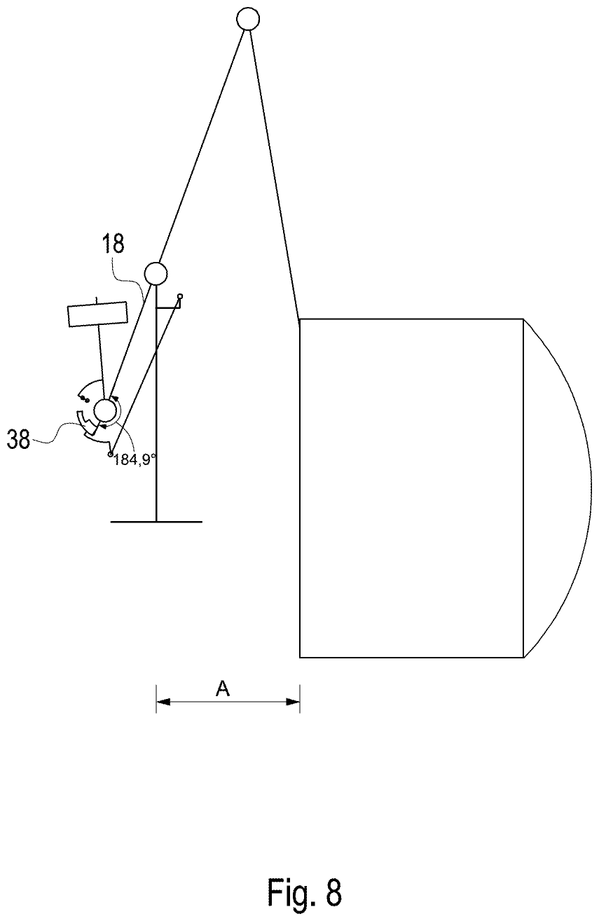

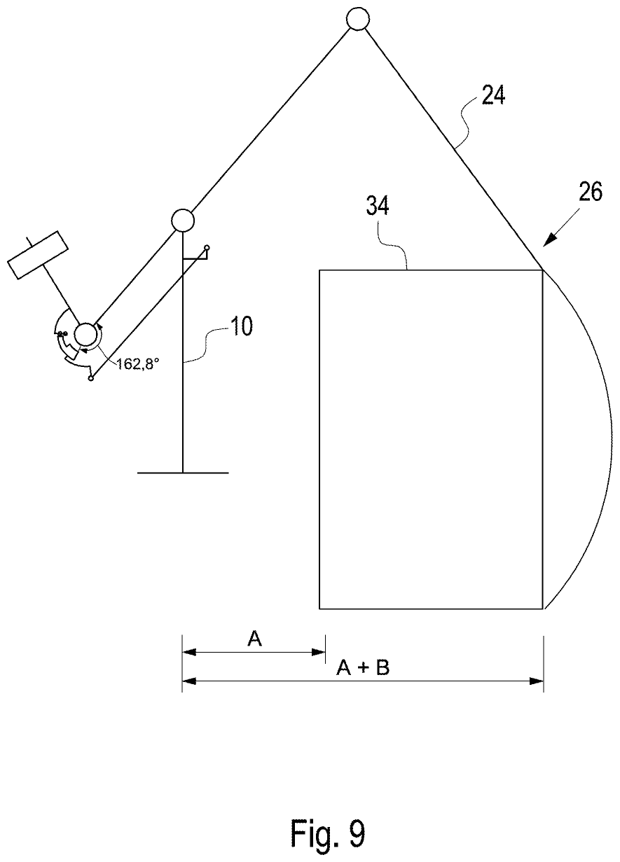

As illustrated in FIGS. 8 and 9, a triggering at the upper position occurs at a correspondingly earlier time than in prior art. Due to the movable connection of the switching element 38 with the rear arm 18, the switching operation is already triggered (FIG. 9) when the outer end of the external arm 24 is at the edge of the working range 34. Thus, at the upper working position, triggering happens much earlier than with a device according to prior art (FIG. 3). Therefore, it is especially at this extreme position that significantly smaller forces and moments occur, since the distance between the base element 10 and the outer end 26 is only A+B.

1. A loading arm device, in particular for loading fluids, comprising:
a base element pivotally supporting a main arm,
an external arm pivotally connected with a front end of the main arm,
a counter-weight arm connected with a rear part of the main arm,
a coupling element mechanically coupling the counter-weight arm with the external arm such that the counter-weight arm and the external arm are parallel to each other at different swivel positions, and
a switching element comprising two switching elements, wherein the switching elements can be rotated relative to each other, so as to trigger a switching operation at a variable maximum scissors angle a between the main arm and the external arm,
wherein one of the switching elements is fixedly connected with the counter-weight arm or the external arm, and the other switching element is rotatably connected with the main arm.

2. The loading arm device of claim 1, wherein the rotatable switching element is connected with the base element or a stationary support element via an actuation element.

3. The loading arm device of claim 2, wherein the actuation element comprises an actuation linkage.

4. The loading arm device of claim 1, wherein the main arm is connected with the base element via a hinge.

5. The loading arm device of claim 4, wherein the main arm comprises an internal arm which, at one end, is mounted to the hinge and at which, at another end, the external arm is arranged, the main arm further comprising a rear arm to which the counter-weight arm is mounted, said rear arm moving at the same time and in the same direction as the internal arm.

6. The loading arm device of claim 5, wherein the rotatable switching element is rotatably connected with the rear arm and the fixed switching element is fixedly connected with the counter-weight arm.

7. The loading arm device of claim 5, wherein the rotatable switching element is rotatably connected with the internal arm and the fixed switching element is fixedly connected with the external arm.

8. The loading arm device of claim 1, wherein one of the switching elements is configured as a switching plate and the other of the switching elements is configured as a proximity switch.

9. The loading arm device of claim 1, wherein the coupling element comprises at least one of a coupling linkage and coupling cables.

10. The loading arm device of claim 1, wherein at an initial position, at least one of the rotatable switching element and the fixed switching element can be set to fix the maximum scissors angle.

11. The loading arm device of claim 10, wherein the initial position can be set via the rotatable switching element by means of an actuation element.

12. The loading arm device of claim 1, wherein a free end of the external arm carries a coupling element for connection to a fluid line.

13. The loading arm device of claim 1, wherein the maximum scissors angle changes dependent upon the position of the main arm.
